(19) United States
(12) Patent Application Publication
(10) Pub. No.: US 2022/0260164 A1
(43) Pub. Date: Aug. 18, 2022

(54) CHECK VALVE

(71) Applicant: SWAGELOK COMPANY, Solon, OH (US)

(72) Inventors: Mark A. Clason, Orwell, OH (US); Branden W. Keeper, Chagrin Falls, OH (US); Andrew P. Marshall, University Heights, OH (US)

(21) Appl. No.: 17/612,267

(22) PCT Filed: May 20, 2020
(86) PCT No.: PCT/US2020/033676

§ 371 Date: Nov. 18, 2021

Related U.S. Application Data
(60) Provisional application No. 62/850,611, filed on May 21, 2019.
(60) Provisional application No. 62/987,422, filed on Mar. 10, 2020.

(51) Int. Cl. F16K 15/02

(52) U.S. Cl. CPC F16K 15/026

(57) ABSTRACT

A check valve includes a valve body (210) and a valve element (230). The valve body includes an outer circumferential wall (223) extending between an inlet port (221) and an outlet port (222), an inner circumferential wall (245) defining a guide passage extending to a radial wall, one or more outer peripheral flow passages between the inner circumferential wall and the outer circumferential wall and extending from the inlet port to the outlet port, and a valve seat (225) surrounding the inlet port. The valve element is retained in the guide passage and is movable between a closed position and an open position. The valve body includes a body housing (220) defining the outer circumferential wall and a carrier member (240) assembled with the body housing and defining the inner circumferential wall and the radial wall. The valve seat comprises an annular seal member retained between an end face of the carrier member and a counterbore portion of the body housing.

### CROSS-REFERENCE TO RELATED APPLICATIONS

This application claims priority to and all benefit of U.S. Provisional Patent Application Ser. No. 62/850,611, filed on May 21, 2019, entitled CHECK VALVE, and U.S. Provisional Patent Application Ser. No. 62/987,422, filed on Mar. 10, 2020, entitled CHECK VALVE, the entire disclosures of both of which are incorporated herein by reference.

### BACKGROUND

Check valves are used to allow flow in one direction but then close off flow in the reverse direction to prevent undesirable back flow in piping systems. The valve element (e.g., poppet) of a check valve typically has two main forces acting upon it, the closing force that can be generated by a spring, magnet, or gravity and the opening force generated from the upstream fluid. Valve chatter can occur when the forces are balanced (i.e., offsetting) and there are instabilities in the flow of system media. It is often advantageous to have the force acting to open the poppet measurably greater than the force to close the valve; however, this is typically achieved with a tradeoff in the full stroke of the valve element and a reduction in overall flow capability.

### SUMMARY OF THE DISCLOSURE

In accordance with an embodiment of one or more of the inventions presented in this disclosure, a check valve includes a valve body and a valve element. The valve body includes an outer circumferential wall extending between an inlet port and an outlet port, an inner circumferential wall defining a guide passage extending to a radial wall, one or more outer peripheral flow passages between the inner circumferential wall and the outer circumferential wall and extending from the inlet port to the outlet port, and a valve seat surrounding the inlet port. The valve element is retained in the guide passage and is movable between a closed position and an open position. The valve body includes a body housing defining the outer circumferential wall and a carrier member assembled with the body housing and defining the inner circumferential wall and the radial wall. The valve seat includes an annular seal member retained between an end face of the carrier member and a counterbore portion of the body housing.

In accordance with another embodiment of one or more of the inventions presented in this disclosure, a check valve includes a valve body and a valve element. The valve body includes an outer circumferential wall extending between an inlet port and an outlet port, an inner circumferential wall defining a guide passage extending to a radial wall, one or more outer peripheral flow passages between the inner circumferential wall and the outer circumferential wall and extending from the inlet port to the outlet port, and a valve seat surrounding the inlet port. The valve element is retained in the guide passage and is movable between a closed position and an open position. The valve body includes a body housing defining the outer circumferential wall and a carrier member assembled with the body housing and defining the inner circumferential wall and the radial wall. The carrier member is threadably installed in a threaded portion of the body housing and includes an interlocking portion that is staked into interlocking engagement with the threaded portion of the body housing to secure the carrier member against threaded adjustment in the body housing

In accordance with another embodiment of one or more of the inventions presented in this disclosure, a check valve includes a body housing defining inlet and outlet ports and a valve cavity therebetween, a carrier member installed in the valve cavity, an annular elastomeric valve seat, and a valve element. The carrier includes a central bore intersecting with one or more outer radial cutouts to define one or more outer peripheral flow passages between the carrier member and an interior surface of the valve cavity, and a central guide passage separated from the outer peripheral flow passages by an inner circumferential wall. The elastomeric valve seat is compressed between an end face of the carrier member and a counterbore in the body housing surrounding the inlet port. The carrier member end face and the body housing counterbore together define an annular seal cavity shaped to retain the elastomeric valve seat while exposing an inner sealing portion of the elastomeric valve seat. The valve element is received in the guide passage and includes a front portion sized and contoured for sealing engagement with the sealing portion of the elastomeric valve seat when the valve element is in a closed position.

### BRIEF DESCRIPTION OF THE DRAWINGS

Further advantages and benefits will become apparent to those skilled in the art after considering the following description and appended claims in conjunction with the accompanying drawings, in which:

FIG. 1 is a cross-sectional schematic view of a check valve in accordance with an exemplary embodiment of the present disclosure;

FIG. 2 is a perspective view of a check valve in accordance with another exemplary embodiment of the present disclosure;

FIG. 3 is an exploded perspective view of the check valve of FIG. 2;

FIG. 4 is a side cross-sectional view of the check valve of FIG. 2, shown in a closed position;

FIG. 5 is a side cross-sectional view of the check valve of FIG. 2, shown in a partially open position;

FIG. 6 is a side cross-sectional view of the check valve of FIG. 2, shown in a fully open position;

FIG. 7 is a perspective view of the poppet carrier of the check valve of FIG. 2;

FIG. 8 is a cross-sectional perspective view of a check valve in accordance with another exemplary embodiment of the present disclosure;

FIG. 9A is a perspective view of a threaded carrier in accordance with another exemplary embodiment of the present disclosure;

FIG. 9B is a cross-sectional view of a check valve including the threaded carrier of FIG. 9A;

FIG. 10A is a perspective view of the threaded carrier of FIG. 9A with end portions staked for secure retention within a check valve body;

FIG. 10B is a cross-sectional view of a check valve including the threaded carrier of FIG. 10A;

FIG. 11A is a partial cross-sectional view of the check valve of FIG. 8, shown in an open position;

FIG. 11B is a partial cross-sectional view of the check valve of FIG. 8, shown in a closed position;

FIG. 12 is a perspective view of a carrier in accordance with another exemplary embodiment of the present disclosure; and

FIG. 12A is a perspective view of a carrier in accordance with another exemplary embodiment of the present disclosure.

### DESCRIPTION OF THE EXEMPLARY EMBODIMENTS

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

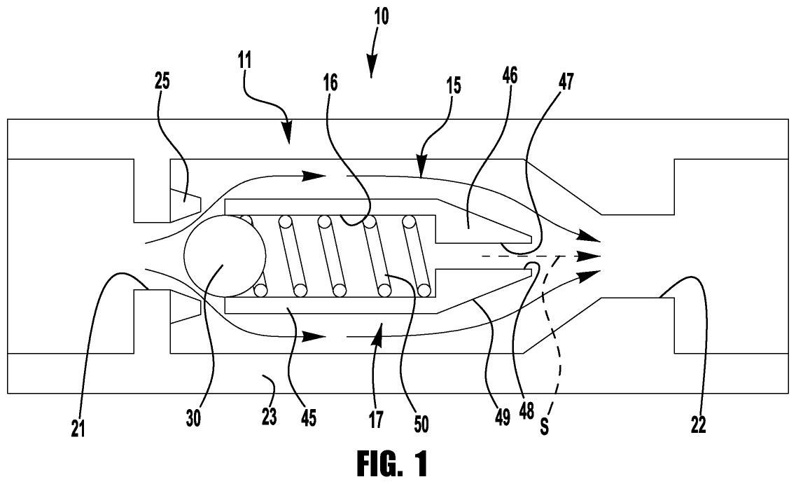

In an exemplary embodiment of the present disclosure, as schematically shown in FIG. 1, a check valve 10 includes a valve body 11 defining inlet and outlet ports 21, 22, an outer circumferential wall 23 and a valve seat 25 surrounding the inlet port. A valve element 30 (e.g., poppet, ball) is retained in a cavity 15 in the valve body 11 and movable in an internal guide passage 16 (e.g., defined by an inner circumferential wall 45) between a first, closed position in which the valve element seals against the valve seat 25, for example, to block backflow to the inlet port 21 or low pressure flow from the inlet port, and a second, open position in which fluid flow is permitted through one or more flow passages 17 between the inlet port and the outlet port 22—as shown, in an outer peripheral space between the inner circumferential wall 45 and the outer circumferential wall 23. A biasing member 50 installed in the valve cavity 15 (e.g., within the guide passage 16) may apply a biasing force to the valve element 30 to bias the valve element towards the closed position.

According to an aspect of the present disclosure, the check valve 10 may include a suction port 47 connected with the guide passage 16 (e.g., through a radial wall 46 rearward of the inner circumferential wall 45), and the one or more flow passages 17 may be tangentially coincident with a downstream end 48 of the suction port 47, such that high velocity flow and low static pressure (due to the Venturi effect) at the downstream end of the suction port generates a suction force (at s) on the downstream end of the valve element 30. This suction force combines with the positive pressure on the upstream end of the valve element 30 to provide an increased opening force, thereby minimizing or eliminating chatter of the valve element in the open position, without requiring a reduction in stroke length of the valve element.

Orienting the flow passages for high velocity, low static pressure suction at the suction port may involve a variety of suitable configurations. In one such embodiment, the flow passage(s) may extend radially outward from the valve seat 25, along outer peripheral flow passages 17, and then radially inward toward the downstream end 48 of the suction port 47. To direct the flow passage(s) radially inward, the suction port 47 may be surrounded by a tapered (e.g., conical) rear surface 49 of the radial wall 46 proximate to the outlet port 22.

A variety of configurations may be utilized to provide a check valve with a valve element guide passage, suction port, and flow passages arranged to provide valve opening suction forces on the valve element in the open position. In one embodiment, a valve element carrier or carrier member (e.g., ball carrier, poppet carrier) may be assembled in the valve body to define the guide passage, suction port, and flow passages.

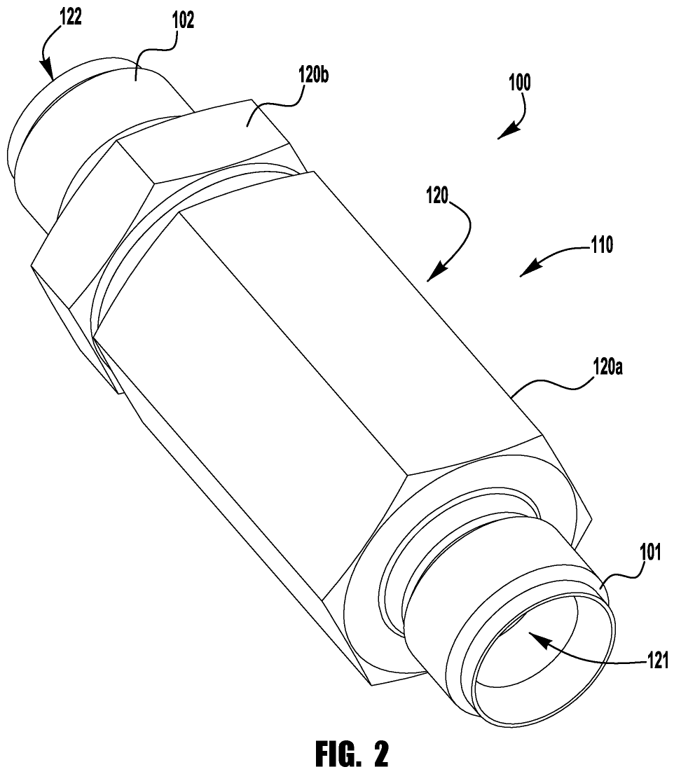

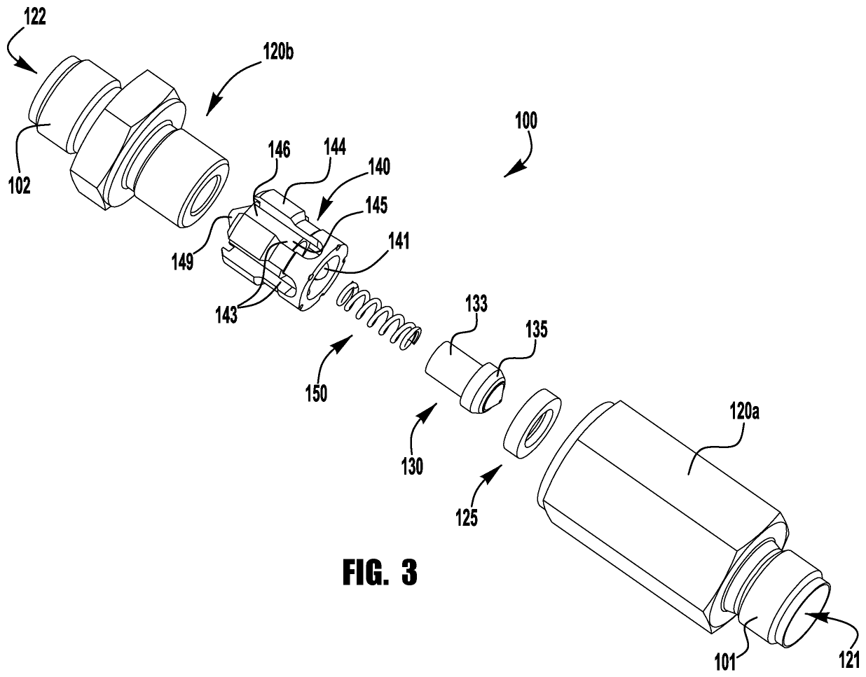

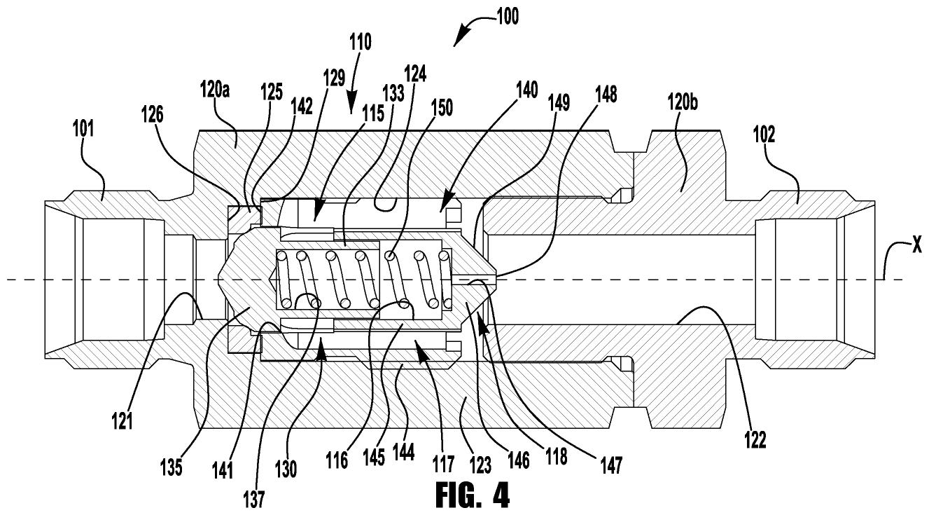

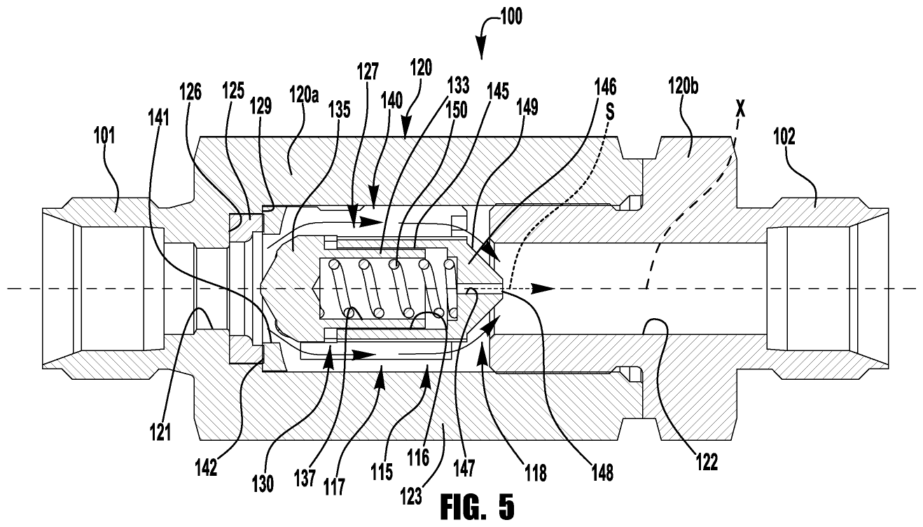

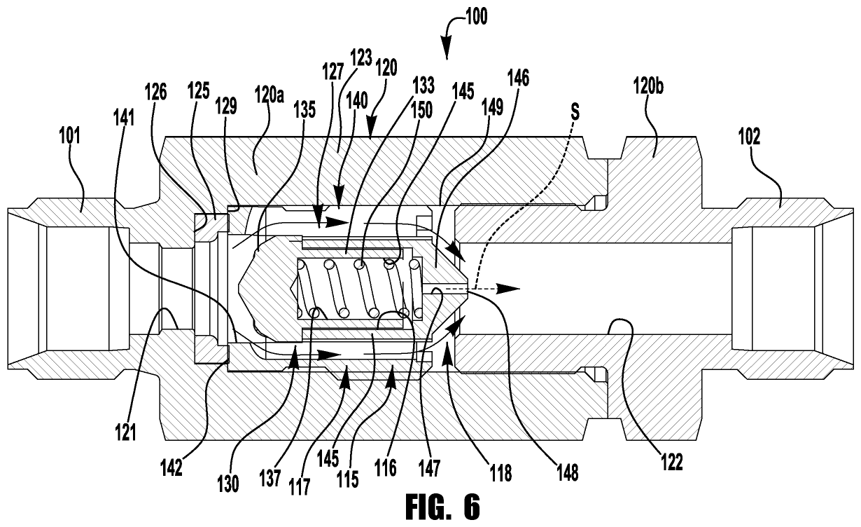

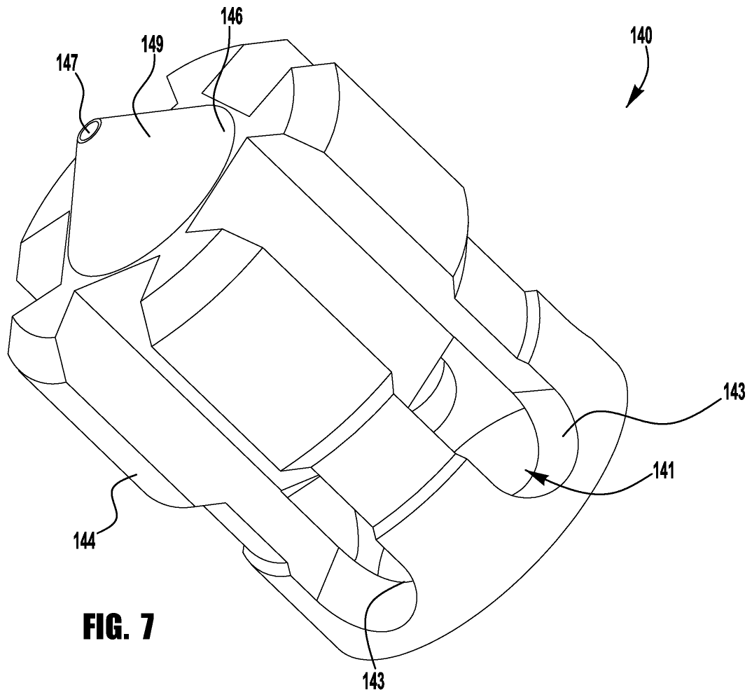

FIGS. 2-7 illustrate an exemplary embodiment of a check valve 100 including a valve body 110, a poppet 130, and a biasing spring 150. While the valve body 110 may be a unitary component, the exemplary valve body 110 includes a body housing 120 formed from first and second body housing members 120a, 120b assembled (e.g., threaded assembly) to define an interior valve cavity 115 and a poppet carrier or carrier member 140 installed in the valve cavity. The body housing 120 includes a first or inlet port 121 disposed in the first body housing member 120a, a second or outlet port 122 disposed in the second body housing member 120b, and an outer circumferential wall 123 extending between the inlet and outlet ports. A valve seat 125 is carried by the first body housing member 120a and is positioned to surround the inlet port 121. The inlet and outlet ports 121, 122 may be provided with end connections 101, 102 (e.g., tube fitting connectors) to assemble the check valve 100 in a fluid system.

The poppet carrier 140 is installed in the valve cavity 115, and includes a central cavity or bore 141 intersecting with outer radial cutouts, slots, or other such apertures 143 to define outer peripheral flow passages 117 between the carrier and the interior surface of the valve cavity 115, and a central guide passage 116 extending axially rearward and connecting with a suction port 147 in a rear radial wall 146 of the carrier 140. While a variety of installation arrangements may be utilized, in the illustrated embodiment, an outer threaded portion 144 of the poppet carrier 140 is threaded with an inner threaded portion 124 of the first body housing member 120a to secure the poppet carrier with the first body housing member.

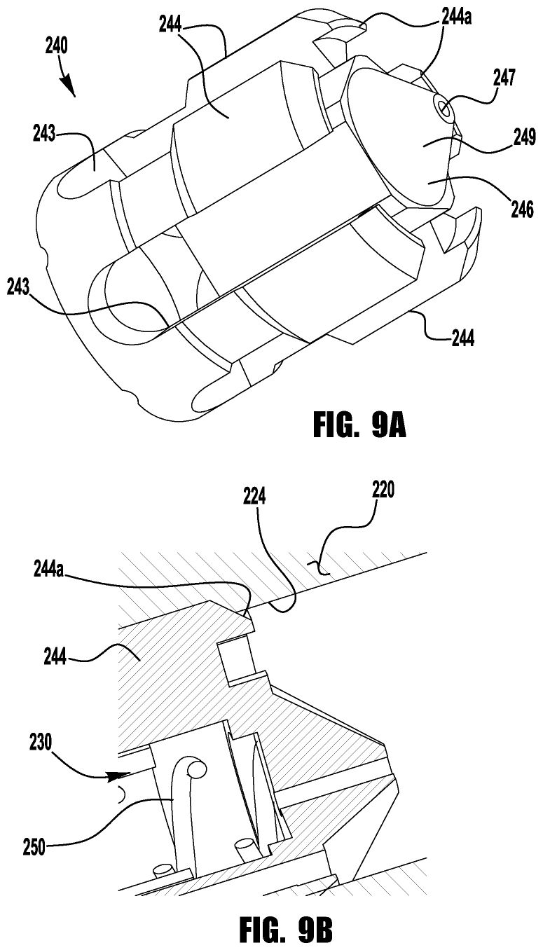

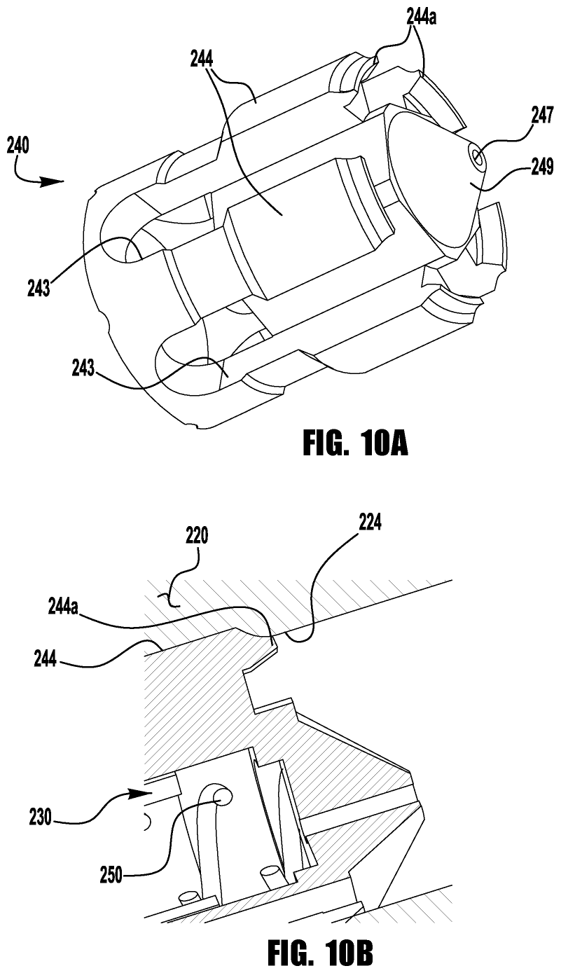

In some embodiments, this threaded installation may be adapted to secure the poppet carrier against inadvertent threaded adjustment, for example, due to system vibrations, thermal cycling, or other such conditions. For example, the installed poppet carrier may be threadably fixed in the installed position using adhesive, welding, or staking of an interelocking portion of the poppet carrier. FIGS. 9A and 9B illustrates an exemplary poppet carrier 240 having an outer threaded portion 244 with axially extending lip portions 244a radially recessed from the body threads 224 when the poppet carrier 240 is initially installed. The lip portions 244a are then staked to flare the lip portions into interference-fit interlocking engagement with the body threads 224, as shown in FIGS. 10A and 10B, to prevent threaded movement (e.g., loosening) of the poppet carrier 240 within the body housing 220.

Referring back to the embodiment of FIGS. 2-7, the poppet 130 includes a rear portion 133 received in the guide passage 116 and a front portion 135 sized and contoured for sealing engagement with the valve seat 125. The biasing spring 150 is disposed in the guide passage 116 between the poppet 130 and the radial wall 146 of the poppet carrier 140, to bias the poppet toward the valve seat 125. As shown, the biasing spring 150 may be partially received in an internal passage 137 in the poppet 130. The poppet 130 is movable in the guide passage 116 between a first, closed position in which the poppet seals against the valve seat 125, for example, to block backflow to the inlet port 121 or low pressure flow from the inlet port, and a second, open position in which fluid flow is permitted through the outer peripheral flow passages 117 between the inlet port and the outlet port 122.

The radial wall 146 of the poppet carrier 140 includes a conical portion 149 extending rearward of the apertures 143 in the poppet carrier 140 to define a radially inward extending downstream portion 118 of the flow passages 117 proximate the outlet port 122. The flow passage downstream portion 118 is tangentially coincident with a downstream end 148 of the suction port 147, such that high velocity flow and low static pressure (due to the Venturi effect) at the downstream end of the suction port generates a suction force on the downstream end of the poppet. This suction force combines with the positive pressure on the upstream end of the poppet 130 to provide an increased opening force, thereby minimizing or eliminating chatter of the poppet in the open position. While different contours may be utilized, in an exemplary embodiment, the tapered (e.g., conical, as shown), flow path defining portion may extend at an angle between about 35° and about 50° with respect to a central axis X of the suction port 147 (which may align with a central axis of the check valve 100, as shown). In other embodiments, other flow path arrangements may provide for similar suction producing flow, such as, for example, inward tapered flow bores in the valve body or poppet carrier.

A variety of valve seats and valve seat installation arrangements may be utilized, including, for example, plastic or elastomeric valve seats. In one such embodiment, a valve seat may be provided in a material selected for extreme temperature or pressure service. For example, a PTFE or PFA valve seat may be utilized for low temperature or cryogenic (e.g., temperatures as low as −200° C. and below) applications. In the illustrated embodiment, the valve seat 125 is an annular plastic (e.g. PTFE or PFA) gland or other such seal member that is compressed between a counterbore 126 in the first body housing member 120a and a forward end face 142 of the poppet carrier 140, thus providing a fluid tight seal between the valve seat and the body housing 120 and poppet carrier 140. The threaded engagement of the poppet carrier 140 with the body housing 120 facilitates this compression. As shown, the end face 142 of the poppet carrier may be configured to engage a shoulder portion 129 in the body housing 120 to limit compression of the valve seat 130 to a desired amount. In other embodiments, the valve seat may be retained in sealing engagement with the valve body independent of the valve element carrier, for example, by staking the valve seat into the valve body or by securing the valve seat with a seat carrier assembled with the valve body (not shown). The valve seat 130 may be provided with a variety of sealing surface contours, including frustoconical (e.g., to closely match a frustoconical surface of the poppet front end) or radiused.

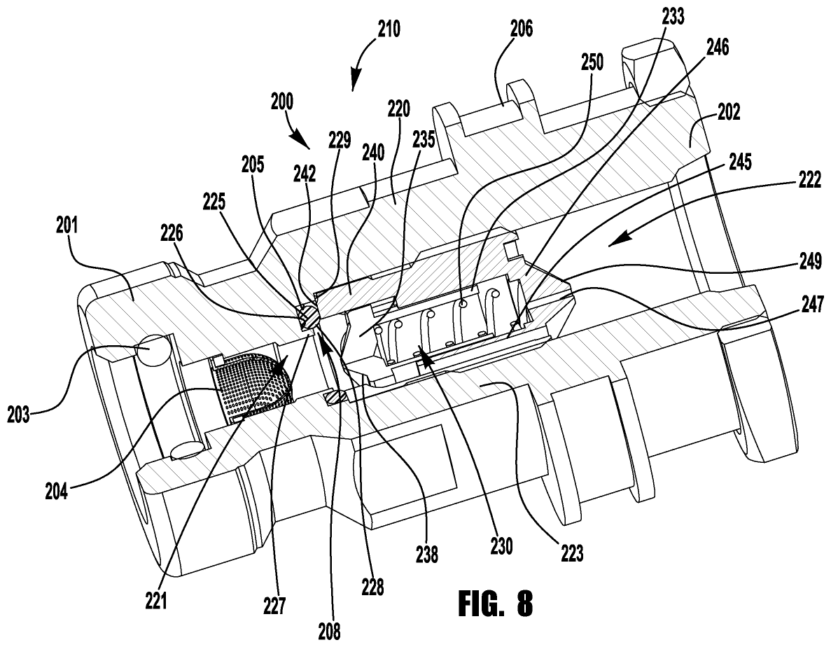

In another embodiment, the valve seat may be provided as an annular elastomeric seal (e.g., O-ring or other such gasket), for example, for use in non-cryogenic (e.g., temperatures at or above −40° C.) systems requiring enhanced sealing capability. In one such arrangement, the valve body may be provided with an inner wall portion extending axially from the counterbore to retain and support the O-ring seal in the counterbore. FIG. 8 illustrates a cross-sectional view of an exemplary check valve 200 similar to the check valve 100 of FIGS. 2-7 (with corresponding components similarly numbered), but having a valve body 210 with a single piece body housing 220 (defining inlet and outlet ports 221, 222 and an outer circumferential wall 223) and an installed poppet carrier or carrier member 240 (defining flow passage forming apertures 243, inner circumferential wall 245, and rear radial wall 246) retaining a valve seat O-ring or other such elastomeric annular seal member 225 positioned in a counterbore 226 of the body housing to surround the inlet port 221. In the illustrated embodiment, the inlet port 221 includes a CNG receptacle end connection 201 with an O-ring seal 203 and filter element 204, and the outlet port 222 includes a threaded SAE connection 202, which may be assembled with an adapter or outlet body housing member to provide any desirable outlet end connection. An outer recessed band 206 may be provided on the valve body to receive an elastic (e.g., rubber or other elastomer) loop portion of an end cap lanyard (not shown), to cover the inlet port when not in use.

In the illustrated embodiment, the valve seat O-ring 225 is axially compressed by a forward end face 242 of the poppet carrier 240, threadably installed against the shoulder 229 in the body housing 220, and secured in place by staked lip portions 244a (as discussed above), thus providing a fluid tight seal between the valve seat 225 and the body housing 220 and poppet carrier 240. The valve seat O-ring 225 is radially retained in the counterbore 226 by an inner wall portion 227 extending axially inward from the counterbore, toward the poppet carrier 240. The counterbore 226, inner wall portion 227 and poppet carrier end face 242 together define an annular seal cavity 205 retaining the valve seat 225 (e.g., in an inner peripheral portion of the seal cavity 205). The seal cavity 205 includes an inner peripheral gap 208 defined by the inner wall portion 227 and poppet carrier end face 242, which exposes a sealing surface 228 of the valve seat O-ring 225, radially aligned with a sealing portion 238 of the poppet front portion 235 to provide a fluid tight seal when the poppet 230 is in the closed position.

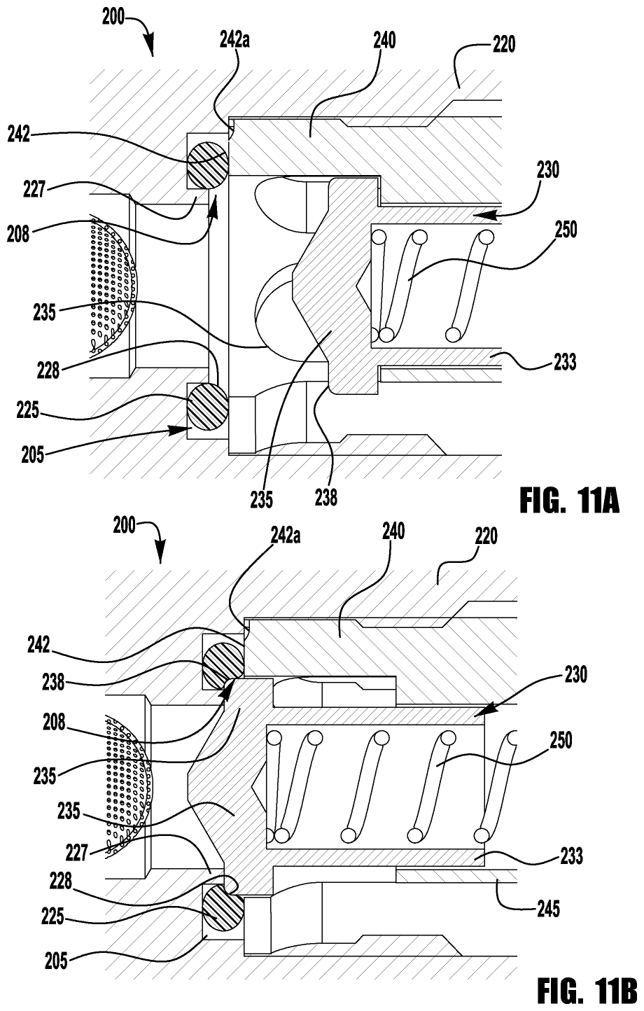

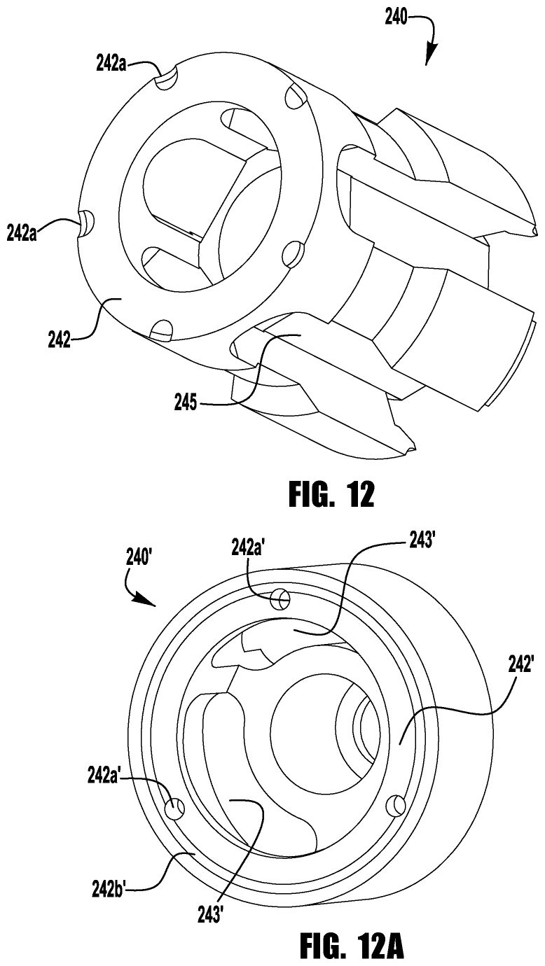

According to another aspect of the present application, the annular seal cavity 205 may be provided with one or more venting passages (e.g., intersecting an outer peripheral portion of the seal cavity) to provide seal-energizing fluid pressure against an outer peripheral surface of the valve seat O-ring 225 when the poppet 235 is in the closed position, and to provide for venting of pressurized fluid from the seal cavity 205 when the poppet is in the open position. This venting when the valve 200 is opened may prevent the valve seat O-ring 225 from being forced through the inner peripheral gap 208 due to a build-up of pressure in the seal cavity 205. As illustrated in FIGS. 11A, 11B, and 12, the end face 242 of the poppet carrier 240 may be provided with one or more outer peripheral notches 242a that define vent passages for the annular seal cavity 205. When the valve 200 is opened (due to sufficient positive fluid pressure applied to the poppet front portion 235, overcoming the forces of the biasing spring 250), pressure around the outer periphery of the seal cavity 205 is vented through the outer peripheral notches 242a to the fluid flow passages 217 of the valve cavity. When the valve 200 is closed (due to forces of the biasing spring 250 overcoming any upstream fluid pressure), pressurized downstream fluid passes through the outer peripheral notches 242a into the outer periphery of the seal cavity 205 to pressurize or energize the valve seat O-ring 225, thereby facilitating sealing engagement between the valve seat O-ring sealing surface 228 and the poppet sealing portion 238.

Other vent passage arrangements may additionally or alternatively be used. For example, as shown in FIG. 10A, a poppet carrier 240′ may be provided with one or more vent holes 242a′ in the end face 242′, extending to intersect with the carrier apertures 243′. As shown, a groove 242b′ intersecting the vent holes 242a′ may also be provided in the end face 242′ to facilitate uniform circumferential venting and energizing pressurization of the seal cavity.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A check valve comprising:
a valve body including an outer circumferential wall extending between an inlet port and an outlet port, an inner circumferential wall extending from an open inlet end to a radial wall at an outlet end to define a guide passage and one or more outer peripheral flow passages between the inner circumferential wall and the outer circumferential wall and extending from the inlet port to the outlet port, and a valve seat surrounding the inlet port; and
a valve element retained in the guide passage and movable between a closed position in which the valve element seals against the valve seat, and an open position in which fluid flow is permitted through the one or more flow passages from the inlet port to the outlet port;
wherein the valve body includes a body housing defining the outer circumferential wall and a carrier member assembled with the body housing and defining the inner circumferential wall and the radial wall; and
wherein the valve seat comprises an annular seal member retained between an end face of the carrier member and a counterbore portion of the body housing.

2. The check valve of claim 1, wherein the body housing includes a first body housing member defining the inlet port and a second body housing member assembled with the first body housing member and defining the outlet port.

3. The check valve of claim 1, wherein the body housing is a unitary body housing defining the inlet port and the outlet port.

4. The check valve of claim 1, wherein the carrier member is threadably installed in a threaded portion of the body housing.

5. The check valve of claim 4, wherein the carrier member is secured against threaded adjustment in the body housing.

6. The check valve of claim 5, wherein the carrier member include an interlocking portion that is staked into interlocking engagement with the threaded portion of the body housing to secure the carrier member against threaded adjustment in the body housing.

7. The check valve of claim 1, wherein the carrier member includes one or more radial apertures defining the one or more outer peripheral flow passages between the carrier member and an interior surface of the valve cavity

8. The check valve of claim 1, wherein the annular seal member comprises a plastic gland.

9. The check valve of claim 1, wherein the annular seal member comprises an elastomeric seal.

10. The check valve of claim 9, wherein the body housing includes an inner wall portion extending from an inner diameter of the counter bore to define an annular seal cavity retaining the elastomeric seal.

11. The check valve of claim 10, comprising at least one vent passage connecting the annular seal cavity to the one or more flow passages.

12. The check valve of claim 11, wherein the at least one vent passage is defined by at least one notch in the carrier member end face.

13. The check valve of claim 11, wherein the at least one vent passage is defined by at least one hole extending from the carrier member end face and intersecting with an outer radial aperture in the carrier member.

14. The check valve of claim 13, wherein the carrier member end face includes an annular groove intersecting the at least one hole.

15. The check valve of claim 1, wherein the radial wall defines a suction port extending from the guide passage to the outlet port, wherein the one or more flow passages are tangentially coincident with a downstream end of the suction port, such that when the valve element is in the open position, high velocity flow and low static pressure at the downstream end of the suction port generates a suction force on the valve element.

16. The check valve of claim 15, wherein the radial wall includes a conical rear surface.

17. The check valve of claim 15, wherein the radial wall includes a tapered rear surface that extends at an angle between about 35° and about 50° with respect to a central axis of the suction port.

18. The check valve of claim 1, wherein the valve element comprises a poppet.

19. The check valve of claim 1, further comprising a biasing spring, disposed between the radial wall and the valve element, to bias the valve element toward the valve seat.

20. The check valve of claim 19, wherein the biasing spring is partially received in an internal passage in the valve element.

21. A check valve comprising:
a valve body including an outer circumferential wall extending between an inlet port and an outlet port, an inner circumferential wall extending from an open inlet end to a radial wall at an outlet end to define a guide passage and one or more outer peripheral flow passages between the inner circumferential wall and the outer circumferential wall and extending from the inlet port to the outlet port, and a valve seat surrounding the inlet port; and
a valve element retained in the guide passage and movable between a closed position in which the valve element seals against the valve seat, and an open position in which fluid flow is permitted through the one or more flow passages from the inlet port to the outlet port;
wherein the valve body includes a body housing defining the outer circumferential wall and a carrier member assembled with the body housing and defining the inner circumferential wall and the radial wall; and
wherein the carrier member is threadably installed in a threaded portion of the body housing, and wherein the carrier member includes an interlocking portion that is staked into interlocking engagement with the threaded portion of the body housing to secure the carrier member against threaded adjustment in the body housing.

22.-31. (canceled)

32. A check valve comprising:
a body housing defining inlet and outlet ports and a valve cavity therebetween;
a carrier member installed in the valve cavity and including a central bore intersecting with one or more outer radial apertures to define one or more outer peripheral flow passages between the carrier member and an interior surface of the valve cavity, and a guide passage separated from the outer peripheral flow passages by an inner circumferential wall;
an annular elastomeric valve seat compressed between an end face of the carrier member and a counterbore in the body housing surrounding the inlet port, the carrier member end face and the body housing counterbore together defining an annular seal cavity shaped to retain the elastomeric valve seat while exposing an inner sealing portion of the elastomeric valve seat; and
a valve element received in the guide passage and including a front portion sized and contoured for sealing engagement with the sealing portion of the elastomeric valve seat when the valve element is in a closed position.

33.-46. (canceled)
